(19) United States
(12) Patent Application Publication
(10) Pub. No.: US 2021/0284175 A1
(43) Pub. Date: Sep. 16, 2021

(54) Non-Intrusive In-Vehicle Data Acquisition System By Sensing Actions Of Vehicle Occupants

(71) Applicant: GM GLOBAL TECHNOLOGY OPERATIONS LLC, Detroit, MI (US)

(72) Inventors: Syed B. Mehdi, Southfield, MI (US); Jeremie Dernotte, Rochester, MI (US); Wei Zeng, Oakland Township, MI (US)

(21) Appl. No.: 16/815,482

(22) Filed: Mar. 11, 2020

(51) Int. Cl. B60W 40/09; B60K 35/00; B60R 11/04; G06K 9/00; G06N 3/08

(52) U.S. Cl. CPC B60W 40/09; B60K 35/00; B60R 11/04; G06K 9/00832; B60W 2050/0078; G06N 3/08; B60W 2540/043; B60W 2540/045; B60W 2540/225; G06K 9/00926

(57) ABSTRACT

A method comprises detecting identities of occupants of a vehicle using any of a camera system, an audio system, a biometric sensing system, and a mobile device detection system in the vehicle. The method comprises matching the detected identities to corresponding profiles of the occupants. The profiles include permissions set by the occupants for collecting data about preferences of the occupants. The method comprises perceiving, based on the permissions in the profiles, preferences of the occupants for inputs received by the occupants. The perceiving includes capturing responses of the occupants to the inputs using any of the camera system, a haptic sensing system, and an audio system in the vehicle, and wherein the perceiving further includes processing the responses using trained models. The method comprises adding the preferences to the profiles to provide content to the occupants based on the preferences stored in the profiles.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to non-intrusive in-vehicle data acquisition systems and methods by sensing actions of vehicle occupants.

Many vehicles are equipped with various sensing devices. Non-limiting examples of the sensing devices include cameras, microphones, haptic sensors, and so on. These sensing devices can be used to collect data about vehicle occupants. The data collected from these sensing devices can be used in many different ways.

### SUMMARY

A method comprises detecting identities of occupants of a vehicle using any of a camera system, an audio system, a biometric sensing system, and a mobile device detection system in the vehicle. The method comprises matching the detected identities to corresponding profiles of the occupants. The profiles include permissions set by the occupants for collecting data about preferences of the occupants. The method comprises perceiving, based on the permissions in the profiles, preferences of the occupants for inputs received by the occupants. The perceiving includes capturing responses of the occupants to the inputs using any of the camera system, a haptic sensing system, and an audio system in the vehicle, and wherein the perceiving further includes processing the responses using trained models. The method comprises adding the preferences to the profiles to provide content to the occupants based on the preferences stored in the profiles.

In another feature, the method further comprises presenting content to the occupants on a device in the vehicle based on the preferences stored in the profiles.

In another feature, the method further comprises suggesting a route for the vehicle based on the preferences stored in the profiles.

In another feature, the inputs include at least one of an object outside the vehicle and content being played in the vehicle.

In another feature, the inputs include a billboard, a landmark, an object, or scenery surrounding the vehicle.

In another feature, the method further comprises creating a profile for one of the occupants not having a profile, receiving a permission setting from the one of the occupants, and perceiving preferences of the one of the occupants according to the permission setting.

In another feature, when the inputs include an object outside the vehicle, the method further comprises identifying the object using a GPS location of the vehicle and either a map of surroundings of the vehicle or data of the surroundings collected by the camera system while the object is perceived.

In other features, when the inputs include an object outside the vehicle, the method further comprises detecting where one of the occupants is gazing based on a GPS location of the vehicle and either stored mapping data or concurrently collected data of surroundings of the vehicle. The method further comprises estimating whether the one of the occupants likes or dislikes the object based on an amount of time for which the one of the occupants views the object and by processing audiovisual data collected from the one of the occupants while viewing the object using one of the trained models.

In other features, when the inputs include content being played in the vehicle, the method further comprises detecting an input from one of the occupants to a device playing the content, determining whether the one of the occupants likes or dislikes the content based on the input, collecting information about the content from the device or from an external source in response to the one of the occupants liking the content, and storing the information in the profile of the one of the occupants.

In other features, when the inputs include content being played in the vehicle, the method further comprises detecting body movement of one of the occupants responsive to the content being played using the trained models and any of the camera system, the haptic sensing system, the audio system. The method further comprises estimating whether the one of the occupants likes or dislikes the content based on the detected body movement. The method further comprises collecting information about the content in response to the one of the occupants liking the content, and storing the information in the profile of the one of the occupants.

In still other features, a system comprises an identity detection system installed in a vehicle. The identity detection system is configured to detect identities occupants of the vehicle by recognizing any of faces, voices, fingerprints, or mobile devices of the occupants. The identity detection system is configured to match the detected identities to corresponding profiles of the occupants. The profiles include permissions set by the occupants for collecting data about preferences of the occupants. The system comprises a sensing system configured to, based on the permissions in the profiles, sense responses of the occupants to inputs received by the occupants in the vehicle using any of a camera system, a haptic sensing system, and an audio system installed in the vehicle; process the responses using trained models; detect preferences of the occupants for the inputs; and add the preferences to the profiles to provide content to the occupants based on the preferences stored in the profiles.

In another feature, the system further comprises an infotainment system configured to present content to the occupants on a device in the vehicle based on the preferences stored in the profiles.

In another feature, the system further comprises an infotainment system configured to suggest a route for the vehicle based on the preferences stored in the profiles.

In another feature, the inputs include at least one of an object outside the vehicle and content being played in the vehicle.

In another feature, the inputs include a billboard, a landmark, an object, or scenery surrounding the vehicle.

In another feature, the sensing system is further configured to create a profile for one of the occupants not having a profile, receive a permission setting from the one of the occupants, and perceive preferences of the one of the occupants according to the permission setting.

In another feature, when the inputs include an object outside the vehicle, the sensing system is further configured to identify the object using a GPS location of the vehicle and either a map of surroundings of the vehicle or data of the surroundings collected by the camera system while the object is perceived.

In other features, when the inputs include an object outside the vehicle, the sensing system is further configured to detect where one of the occupants is gazing based on a GPS location of the vehicle and either stored mapping data or concurrently collected data of surroundings of the vehicle. The sensing system is further configured to estimate whether the one of the occupants likes or dislikes the object based on an amount of time for which the one of the occupants views the object and by processing audiovisual data collected from the one of the occupants while viewing the object using one of the trained models.

In other features, when the inputs include content being played in the vehicle, the sensing system is further configured to detect an input from one of the occupants to a device playing the content, determine whether the one of the occupants likes or dislikes the content based on the input, collect information about the content from the device or from an external source in response to the one of the occupants liking the content, and store the information in the profile of the one of the occupants.

In other features, when the inputs include content being played in the vehicle, the sensing system is further configured to detect body movement of one of the occupants responsive to the content being played using the trained models and any of the camera system, the haptic sensing system, the audio system. The sensing system is further configured to estimate whether the one of the occupants likes or dislikes the content based on the detected body movement. The sensing system is further configured to collect information about the content in response to the one of the occupants liking the content, and store the information in the profile of the one of the occupants.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 shows a plurality of subsystems of a vehicle connected to each other using a Controlled Area Network (CAN) bus in the vehicle;

FIG. 2 shows examples of subsystems that detect occupants' preferences regarding objects observed from the vehicle according to the present disclosure;

FIGS. 3-5 show the subsystems in further detail;

FIG. 6 shows a simplified example of a distributed network system comprising a plurality of client devices, a plurality of servers, and a plurality of vehicles;

FIG. 7 is a functional block diagram of a simplified example of a server used in the distributed network system of FIG. 6;

FIG. 8 shows a method for detecting occupants and their preferences according to the present disclosure;

FIG. 9 shows a method for matching occupants' faces to profiles according to the present disclosure;

FIG. 10 shows a method for perceiving the preferences of the occupants according to the present disclosure;

FIG. 11 shows a method for detecting an occupant's interest in the music being played in the vehicle according to the present disclosure;

FIG. 12 shows a method for detecting an occupant's interest in the music being played in the vehicle according to the present disclosure; and

FIG. 13 shows a method for presenting content to vehicle occupants based on their detected preferences according to the present disclosure.

In the drawings, reference numbers may be reused to identify similar and/or identical elements.

### DETAILED DESCRIPTION

Cameras and other sensors in vehicles can provide useful data on occupants' preferences. For example, a person staring at a billboard or moving along the music being played on the radio can indicate the person's interests. This data can be used for targeted advertisements and making other suggestions to the user (e.g., suggesting destination or route when using navigation). Furthermore, this data can be sold to other companies such as those advertising their products and services on billboards, to radio stations, and so on.

The present disclosure provides systems and methods for collecting data on user preferences using sensors such as cameras/infrared (IR) sensors, etc. in the vehicle. The collected data can be appended to user profiles. Inferences of driver's/passengers' actions drawn based on the collected data can be used to determine their likings and dis-likings (i.e., preferences). This information can then be used to provide targeted advertisements and route suggestions, for example.

Current data collection techniques for learning about people's likings about content in the real world (e.g., billboard ads, music on the radio, etc.) include surveys and rating systems, which are conducted after the fact. Further, it takes considerable time and effort to correlate and sift through the data obtained through surveys and rating systems. Data collection in cases where the content appears on a phone or computer (e.g., a video clip appearing on a social media app) may be performed without a delay and through a non-intrusive system. For example, as a person scrolls through the content being displayed by a social media app, if the person pauses to view the content, it can be inferred that the person is interested in the content. Similar or related content can be displayed using the inferred interest in the viewed content. On the other hand, if the user does not pause to view the content, it can be inferred that the person is not interested in the content. Similar or related content may not be displayed using the inferred lack of interest in the unviewed content. For real world content such as billboards etc., however, this type of data and inference gathering while the content is being viewed and subsequent tailoring of content presentation is not possible.

The systems and methods of the present disclosure can monitor driver/passenger activity during a ride such as where are they pointing (e.g., using hand or head motion), how long their eyes linger on an advertisement on a billboard or on a building, whether a person expressed interest in what is being observed, etc. to enable data collection for content in the real world similar to data collection performed for content that appears online. Users can enable/disable the system. These and other features of the present disclosure are described below in detail.

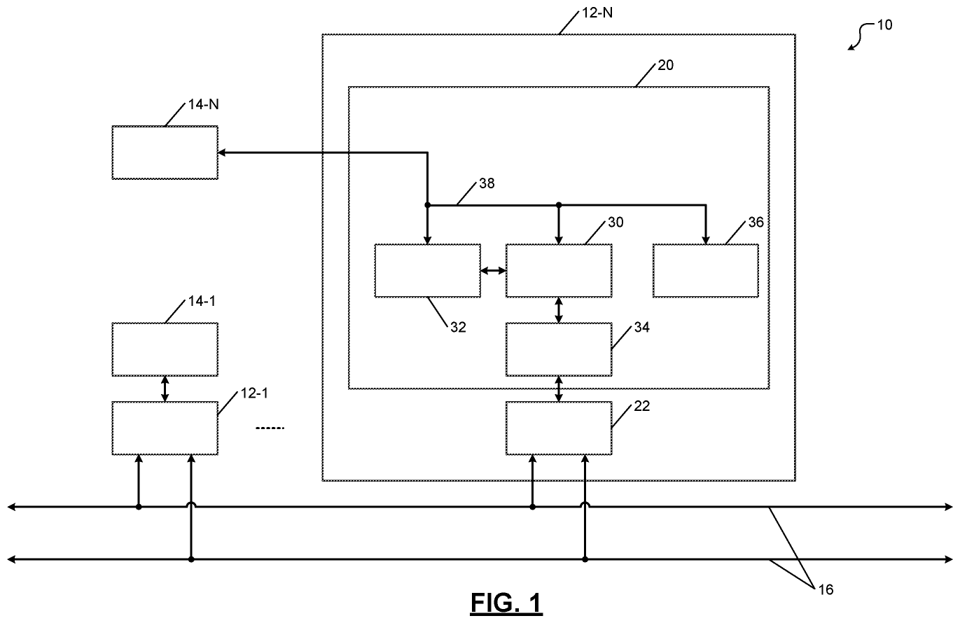

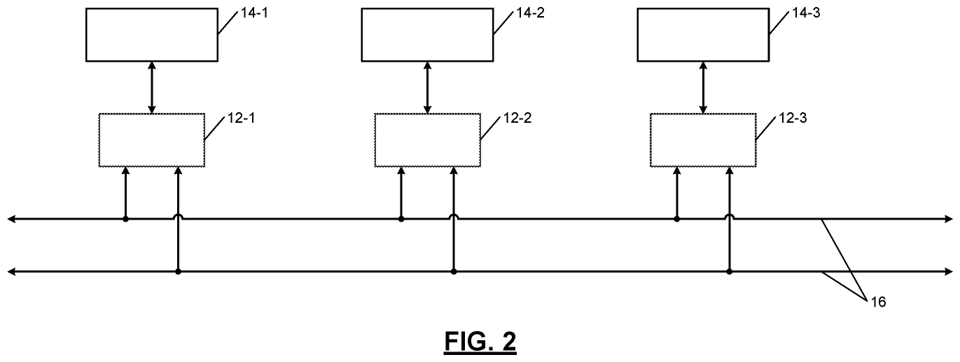

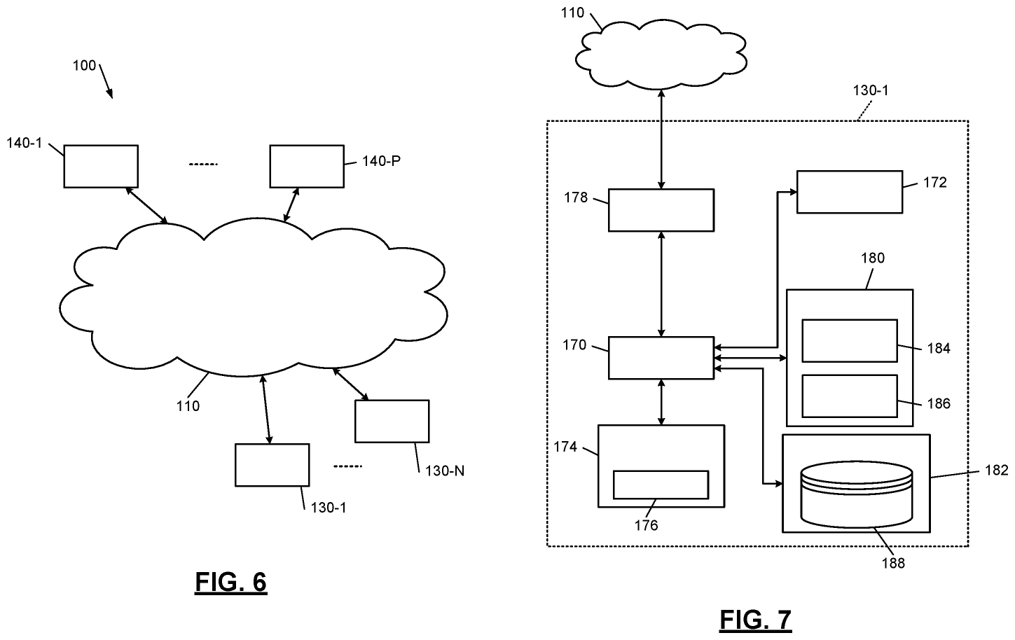

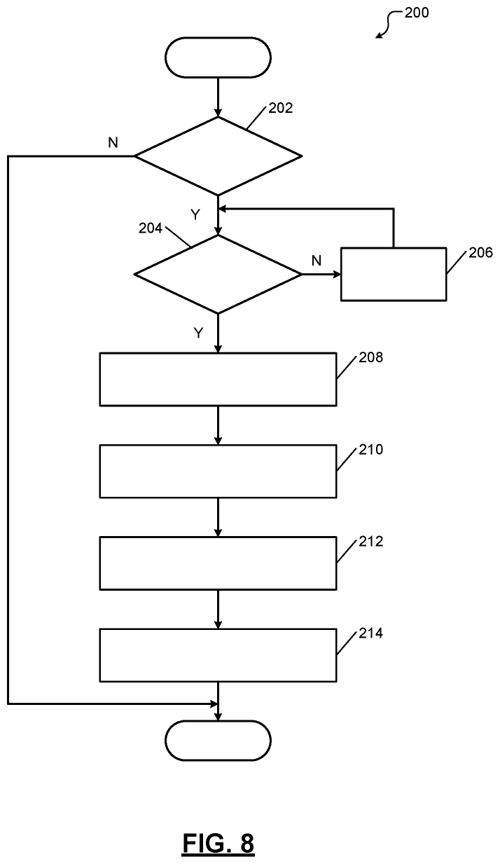

The present disclosure is organized as follows. FIG. 1 shows various subsystems of a vehicle connected to each other using a Controlled Area Network (CAN) bus. FIGS. 2-5 show examples of subsystems relevant to the present disclosure. FIGS. 6-7 show simplistic examples of a distributed computing environment in which the systems and methods of the present disclosure can be implemented. FIGS. 8-13 show various methods that can be implemented using the subsystems of FIGS. 2-5 and the distributed computing environment of FIGS. 6-7.

Throughout the present disclosure, references to terms such as servers, applications, and so on are for illustrative purposes only. The term server is to be understood broadly as representing a computing device comprising one or more processors and memory configured to execute machine readable instructions. The terms applications and computer programs are to be understood broadly as representing machine readable instructions executable by the computing devices.

Automotive electronic control systems are typically implemented as Electronic Control Units (ECU's) that are connected to each other by a Controller Area Network (CAN) bus. Each ECU controls a specific subsystem (e.g., engine, transmission, heating and cooling, infotainment, navigation, and so on) of the vehicle. Each ECU includes a microcontroller, a CAN controller, and a transceiver. In each ECU, the microcontroller includes a processor, memory, and other circuits to control the specific subsystem. Each ECU can communicate with other ECU's via the CAN bus through the CAN controller and the transceiver.

FIG. 1 shows an example of a vehicle 10 comprising a plurality of ECU's connected to each other by a CAN bus. The plurality of ECU's includes ECU-1 12-1, . . . , and ECU-N 12-N (collectively, ECU's 12), where N is an integer greater than one. Hereinafter, ECU 12 refers to any of the plurality of ECU's 12. While FIG. 1 shows a detailed functional block diagram of only the ECU-N 12-N, other ECUs 12 have structure similar to the ECU-N 12-N. Each ECU 12 or any portion thereof can be implemented as one or more modules.

Each ECU 12 controls a respective subsystem of the vehicle 10. For example, the ECU-1 12-1 controls a subsystem 14-1, . . . , and the ECU-N 12-N controls a subsystem 14-N. The subsystems 14-1, . . . , and 14-N are collectively referred to as subsystems 14. Non-limiting examples of the subsystems 14 include an infotainment subsystem, a navigation subsystem, a communication subsystem, a physiological data acquisition subsystem, an audiovisual sensing subsystem, an engine control subsystem, a transmission control subsystem, a brake control subsystem, an exhaust control subsystem, a traction control subsystem, a suspension control subsystem, a climate control subsystem, a safety subsystem, and so on.

Each subsystem 14 may include one or more sensors to sense data from one or more components of the subsystem 14. For example, the physiological data acquisition subsystem may include biometric or biological sensors and haptic sensors to collect physiological and haptic data from occupants of the vehicle 10. The audiovisual sensing subsystem may include cameras, infrared (IR) systems, and microphones to collect data such as movement, gestures, and utterances of vehicle occupants. The physiological data acquisition subsystem and the audiovisual sensing subsystem may be collectively called a sensing subsystem. The communication subsystem may include one or more transceivers for wireless (e.g., cellular, WiFi, etc.) communication, a GPS system for navigation, and so on. The infotainment subsystem may include a radio receiver, a satellite receiver, and one or more displays including a display console on the dashboard of the vehicle 10 and a plurality of displays for individual occupants of the vehicle 10. The safety subsystem may include additional cameras located throughout the vehicle for autonomous and safe driving (e.g., for lane tracking, backing up and parking, capturing images of vehicle's surroundings for safety and mapping purposes); and so on. The safety subsystem may also be included in the sensing subsystem.

Further, each subsystem 14 may include one or more actuators to actuate one or more components of the subsystem 14. An ECU 12 may receive data from one or more sensors of a corresponding subsystem 14. Depending on the type of ECU, the ECU 12 may also receive one or more inputs from an occupant of the vehicle 10. The ECU 12 may control one or more actuators of the corresponding subsystem 14 based on the data received from the one or more sensors and/or the one or more inputs from an occupant of the vehicle 10.

The ECUs 12 are connected to a CAN bus 16. The ECUs 12 can communicate with each other via the CAN bus 16. The ECUs 12 can communicate with other devices connected to the CAN bus 16 (e.g., test equipment, a communication gateway, etc.). Each ECU 12 includes a microcontroller 20 and a CAN transceiver 22. The microcontroller 20 communicates with the subsystem 14 controlled by the ECU 12. The CAN transceiver 22 communicates with the CAN bus 16 and transmits and receives data on the CAN bus 16.

The microcontroller 20 includes a processor 30, a memory 32, a CAN controller 34, and a power supply 36. The memory 32 includes volatile memory (RAM) and may additionally include nonvolatile memory (e.g., flash memory) and/or other type of data storage device(s). The processor 30 and the memory 32 communicate with each other via a bus 38. The processor 30 executes code stored in the memory 32 to control the subsystem 14. The power supply 36 supplies power to all of the components of the microcontroller 20 and the ECU 12. The CAN controller 34 communicates with the CAN transceiver 22.

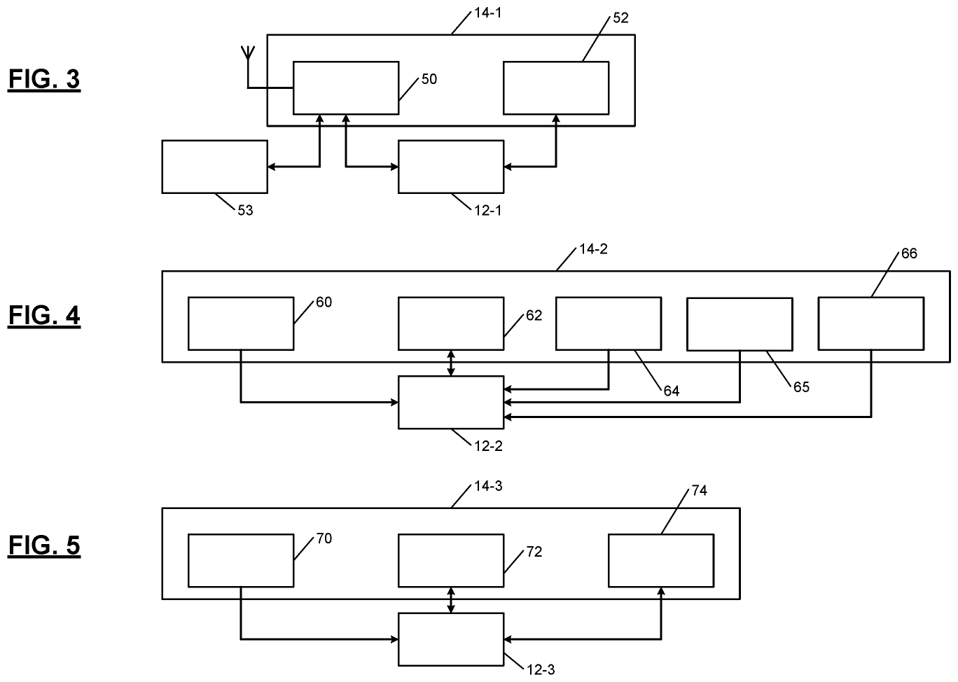

FIGS. 2-5 show examples of subsystems relevant to the present disclosure. Each of the subsystems, systems, and ECU's shown can be implemented as modules. In FIG. 2, the ECU 12-1 communicates with the CAN bus 16 and controls the communication subsystem 14-1, which is shown in detail ion FIG. 3. The ECU 12-2 communicates with the CAN bus 16 and controls the sensing subsystem 14-2, which is shown in detail in FIG. 4. The ECU 12-3 communicates with the CAN bus 16 and controls the infotainment subsystem 14-3, which is shown in detail in FIG. 5.

In FIG. 3, the communication subsystem 14-1 comprises wireless (e.g., cellular, WiFi, Bluetooth, etc.) transceiver(s) 50 and a navigation system 52 such as a GPS system. Mobile devices 53 such as smartphones of occupants of the vehicle 10 can be paired with the vehicle 10 via the wireless transceiver(s) 50, and pairing data can be stored in memory in the communication subsystem 14-1. The pairing data can be used to recognize (i.e., detect) and identify persons upon their entry into the vehicle 10. Accordingly, a portion of the communication subsystem 14-1 may also function as a mobile device detection system and therefore be called as the mobile device detection system, which can be used to detect and identify occupants of the vehicle 10.

The wireless transceivers 50 can be used to communicate with one or more remote servers in a cloud, for example. The GPS coordinates of the vehicle 10 can be used to identify an object that an occupant is gazing while the vehicle 10 is being driven on a road. The object can be identified using a map of the road that is already previously created (e.g., using the cameras onboard the vehicle 10). Alternatively, the object can be identified by collecting data about the surroundings of the vehicle 10 using the cameras onboard the vehicle 10 while the occupant is gazing the object as described below.

In FIG. 4, the sensing subsystem 14-2 comprises a camera system 60, an IR sensing system 62, an audio sensing system 64, a biometric sensing system 65, and a haptic sensing system 66. For example, the camera system 60 may comprise one or more cameras located within the interior of the vehicle 10. For example, the cameras may be focused on headrests of each seat in the vehicle 10 to capture the facial images and other gestures of occupants of the vehicle 10. For example, additional or alternate cameras may be located throughout the vehicle (e.g., on the dash board, near the rear-view mirror, and in front, rear, and side exterior portions of the vehicle 10). The cameras on the dashboard/mirror can capture images of the driver/occupants. The exterior cameras can capture images of the surroundings of the vehicle 10 (e.g., billboards, sign boards, etc.). A map of roads comprising information about locations of various sign boards can be provided by a backend server in a cloud (described below with reference to FIGS. 6-7). Such a map may be created, for example, through hand curation (e.g., billboard owner may voluntarily provide the information) or based on data collected through the cameras in front, rear, and side exterior portions of the vehicle 10. The map may be created ad hoc, or the data about the surroundings of the vehicle 10 can be obtained on the fly (i.e., in near real time, as the vehicle 10 is being driven).

For example, the IR sensing system 62 comprises a gaze tracking sensor per occupant to detect where an occupant is looking. The gaze tracking sensor includes a light source and an infrared camera per occupant of the vehicle 10. The light source directs near-infrared light towards the center of the eyes (pupils) of an occupant, causing detectable reflections in both the pupil and the cornea (an outer-most optical element of the eye). These reflections—the vector between the cornea and the pupil—are tracked by the infrared camera to detect the gaze or where an occupant is looking. The IR sensing system 62 can determine in what order an individual looked at objects and for how long. The IR sensing system 62 can use heat maps to determine where the occupants focused their visual attention. The IR sensing system 62 can determine areas of interest to the occupants based on how the occupants focused on one object versus another.

For example, the audio sensing system 64 comprises a microphone that can detect exclamatory expressions of the occupants such as “look at that!” or “did you see that?” or “oh look!” or “I love (or hate) that sign/ad/billboard!” and so on. The audio sensing system 64 can include filters that can detect such expressions and ignore the rest of the conversations or sounds in the vehicle 10. The audio sensing system 64 can also accept inputs from occupants for creating profiles, which are described below with reference to FIGS. 8-13.

For example, the haptic sensing system 66 comprises various haptic sensors that can detect various movements of the occupants of the vehicle 10. For example, the haptic sensors can detect tapping of fingers on steering wheel, movements in seat, and so on. The haptic sensing system 66 can include trained models to detect movements of the occupants based on the outputs of the haptic sensors. For example, the haptic sensing system 66 can detect if an occupant is moving in rhythm of the music being played in the vehicle 10 or is moving in other ways for other reasons. Additionally, movements (e.g., of arms and head) captured by cameras, sounds captured by microphone (e.g., clapping, verbal expressions, etc.) can also be combined with data from the haptic sensors. This information is used to infer user preferences as described below with reference to FIGS. 8-13.

For example, the biometric sensing system 65 can include fingerprint sensors installed in door handles of the vehicle 10 to recognize and identify the occupants of the vehicle 10. In addition, the audio sensing system 64 can be used to recognize and identify the occupants of the vehicle 10. For example, when a person enters the vehicle 10, the person can simply say something (e.g., hi), and the audio sensing system 64 can recognize and identify the person based thereon. Thus, occupants of the vehicle 10 can be recognized (i.e., detected) and identified using any one of the camera system 60 (recognize and identify occupants using face recognition), the audio sensing system 64 (using voice recognition), the biometric sensing system 65 (using fingerprint recognition), and/or the mobile device based recognition described above. Any of these systems can therefore be called an identity detection system. Any combination of these systems and methods may be used for robustness of detection and identification of the occupants of the vehicle 10.

In FIG. 5, the infotainment system 14-3 comprises receivers 70 (e.g., an AM/FM radio receiver, a satellite receiver, etc.), one or more displays 72 (e.g., a display console on the dashboard and displays for individual occupants of the vehicle 10), and a multimedia system 74. For example, the displays 72 may include touchscreens that can be used by the occupants (e.g., instead of or in addition to the microphone) to provide data for generating profiles, which are described below with reference to FIGS. 8-13. The multimedia system 74 can also include interactive input/output devices that can be used to create profiles and to otherwise interact with (e.g., to give commands to) the vehicle 10.

FIG. 6 shows a simplified example of a distributed network system 100. The distributed network system 100 includes a network 110 (e.g., a distributed communication system). The distributed network system 100 includes one or more servers 130-1, 130-2, . . . , and 130-N (collectively servers 130); and one or more vehicles 140-1, 140-2, . . . , and 140-P (collectively vehicles 140), where N and P are integers greater than or equal to 1. The network 110 may include a local area network (LAN), a wide area network (WAN) such as the Internet, a cellular network, or other type of network (collectively shown as the network 110). The servers 130 may connect to the network 110 using wireless and/or wired connections to the network 110.

Each vehicle 140 is similar to the vehicle 10 described above and comprises the ECU's 12 and the subsystems 14 shown in FIG. 1. Throughout the present disclosure, communications with and by the vehicles 140 are to be understood as communications with the ECU's 12 and the subsystems 14 in the vehicles 140. For example, in each vehicle 140, the communication module 14-1 may execute an application that communicates with the sensing subsystem 14-2 and the infotainment subsystem 14-3 and that also communicates with the servers 130 via the network 110. The vehicles 140 (i.e., the communication modules 14-1 of the vehicles 140) may communicate the network 110 using wireless connections to the network 110.

The servers 130 may provide multiple services to the vehicles 140. For example, the servers 130 may execute a plurality of software applications (e.g., mapping applications, trained models for gaze and gesture detection, content delivery applications, etc.). The servers 130 may host multiple databases that are utilized by the plurality of software applications and that are used by the vehicles 140. In addition, the servers 130 and the vehicles 140 may execute applications that implement at least some portions of the methods described below with reference to FIGS. 8-13.

FIG. 7 shows a simplified example of the servers 130 (e.g., the server 130-1). The server 130-1 typically includes one or more CPUs or processors 170, one or more input devices 172 (e.g., a keypad, touchpad, mouse, and so on), a display subsystem 174 including a display 172, a network interface 178, a memory 180, and a bulk storage 182.

The network interface 178 connects the server 130-1 to the distributed network system 100 via the network 110. For example, the network interface 178 may include a wired interface (e.g., an Ethernet interface) and/or a wireless interface (e.g., a Wi-Fi, Bluetooth, near field communication (NFC), cellular, or other wireless interface). The memory 180 may include volatile or nonvolatile memory, cache, or other type of memory. The bulk storage 182 may include flash memory, one or more hard disk drives (HDDs), or other bulk storage device.

The processor 170 of the server 130-1 may execute an operating system (OS) 184 and one or more server applications 186. The server applications 186 may include an application that implements the methods described below with reference to FIGS. 8-13. The bulk storage 182 may store one or more databases 188 that store data structures used by the server applications 186 to perform respective functions.

In FIGS. 8-13, various methods for detecting occupants, matching (or creating if necessary) profiles of occupants, detecting occupants' preferences, updating the profiles with the detected preferences, and presenting content based on the preferences are shown. FIG. 8 shows the broadest method. Subsequent methods describe each aspect of the method shown in FIG. 8 in further detail. These methods are implemented by the applications executed by the servers 130 and the vehicles 140. In the following description, the term control represents code or instructions executed by one or more components of the servers 130 and the vehicles 140 shown in FIGS. 1-7. The term control refers to one or more of the server applications 186 and the applications executed by the systems and subsystems of the vehicles 140 that are described with reference to FIGS. 1-5.

FIG. 8 shows a method 200 for detecting occupants and their preferences according to the present disclosure. At 202, control determines if the system for detecting occupants and their preferences is enabled. The method 200 ends if the system is not enabled. At 204, if the system is enabled, control determines if all the doors of the vehicle are closed (i.e., all occupants are in the vehicle). If not, at 206, control resets the system and returns to 204. If the vehicle doors are closed, control proceeds to 208.

At 208, control detects faces (or fingerprints, voices, mobile devices) of all occupants of the vehicle (e.g., by capturing images of their faces, or data about their fingerprints, voices, or mobile devices and matching them to the corresponding data stored in a database in the remote server). At 210, control matches the detected faces (or fingerprints, voices, mobile devices) to the corresponding profiles of the occupants (e.g., the profiles stored in a database in the remote server). At 212, control perceives each occupant's preferences (as explained below) and adds them to their respective profiles if settings in the profiles allow. At 214, control presents content to the occupants based on their detected preferences.

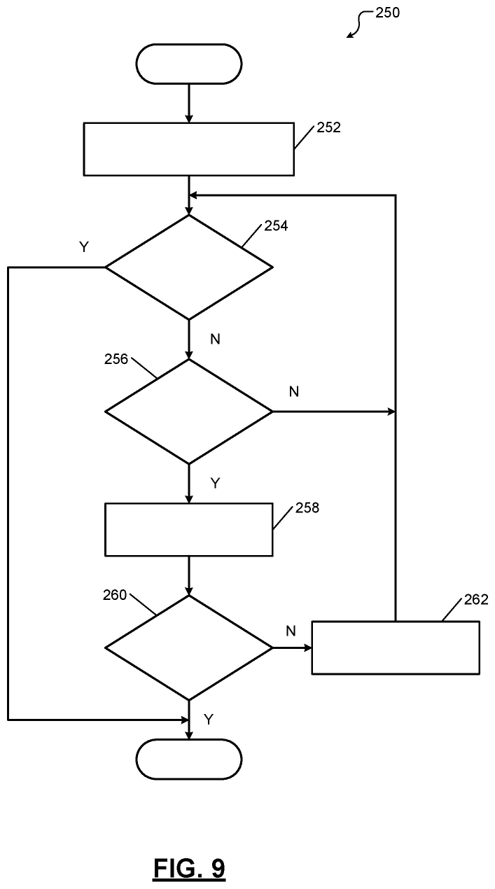

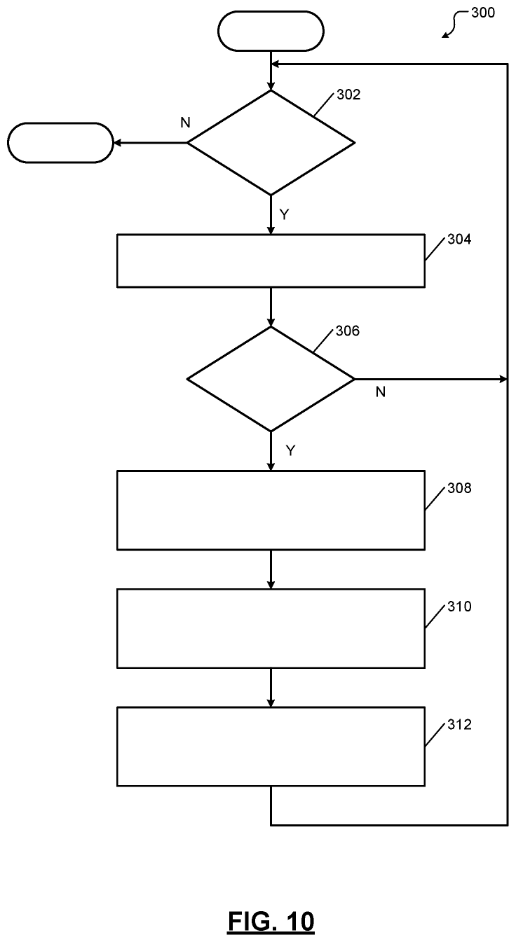

FIG. 9 shows a method 250 for matching occupants' identities to profiles according to the present disclosure. The method 250 explains the steps 208 and 210 of the method 200 shown in FIG. 8 in further detail. At 252, for each occupant, control identifies the detected face (or fingerprints, voices, mobile devices), locates an existing profile for the identified person, and matches the detected face (or fingerprints, voices, mobile devices) to the profile. At 254, control determines if all the detected faces (or fingerprints, voices, mobile devices) are matched to their respective profiles. The method 250 ends if all the detected faces (or fingerprints, voices, mobile devices) are matched to their respective profiles.

At 256, if all the detected faces (or fingerprints, voices, mobile devices) are not matched to their respective profiles, control determines if a person without a profile wants to create a profile. Control returns to 254 if a person without a profile does not wish to create a profile. At 258, if a person without a profile wants to create a profile, control creates a profile for the person. For example, control prompts the person to enter the person's information such as age, gender, and so on. For example, this interactive exchange for gathering requested information can occur using the audio system, the multimedia system, and so on. For example, the person can provide the information by speaking into the microphone, by using a touchscreen, and so on.

At 260, control determines if the person allows (i.e., consents to) data collection (e.g., detecting and adding the person's preferences) for the profile. The method 250 ends if the person allows the data collection. At 262, if the person disallows the data collection, control disables the data collection for the profile, and control returns to 254.

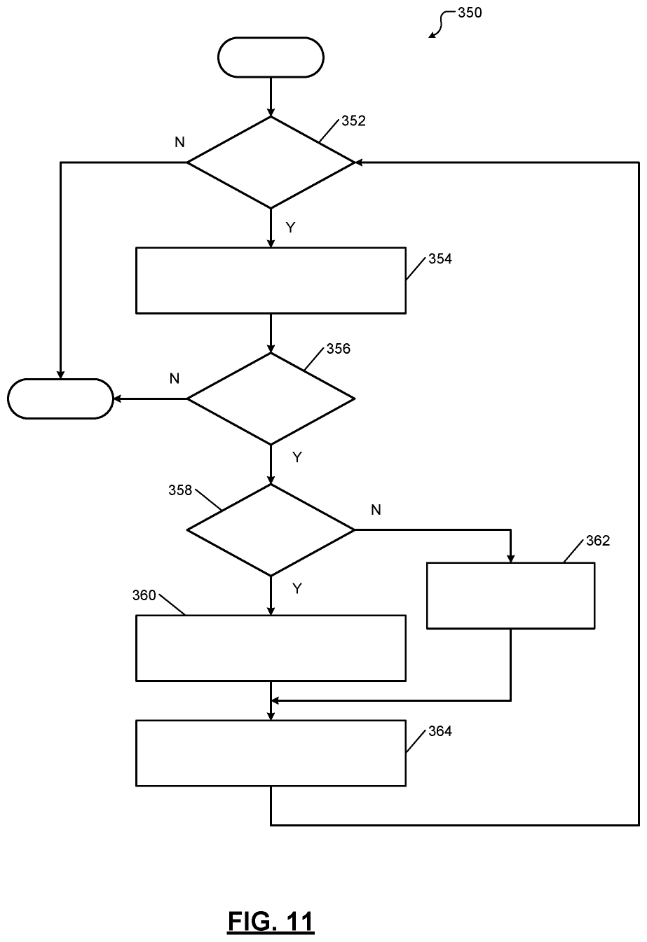

FIG. 10 shows a method 300 for perceiving the preferences of the occupants according to the present disclosure. The method 300 further explains the step 212 of the method 200 shown in FIG. 8. The method 300 is performed for each occupant. At 302, control determines if a person allows data collection regarding the person's preferences. The method 300 ends if a person disallows data collection regarding the person's preferences.

At 304, if a person allows data collection regarding the person's preferences, control detects where the person is looking based on the vehicles GPS data and by detecting the person's gaze (e.g., by using the IR sensing system) or by detecting the turning of the person's head using a camera. Alternatively or additionally, control may also detect where the person is looking by detecting the person's finger pointed to a roadside object, or based on exclamatory expressions described above.

At 306, control determines if the person looks at the object suddenly or the person looks at the same location/object for a significant amount of time sufficient to indicate the person's interest in the location/object. The method 300 restarts if the person does not look at the object suddenly or the person does not look at the same location/object for a significant amount of time.

At 308, if the person looks at the object suddenly or the person looks at the same location/object for a significant amount of time, control determines the type of content (e.g., a billboard, a building, a sign etc.) the person is viewing. Control determines the type of content based on the vehicle's GPS coordinates and mapping data already stored in the remote server, or based on the vehicle's GPS coordinates and data about the vehicle's surroundings collected by the vehicle's cameras concurrently while the person is viewing the content.

At 310, control optionally estimates the person's reaction/emotion indicating the person's liking/disliking for the content being viewed. Control estimates the person's reaction/emotion's based on audiovisual data of the person collected using microphone/camera while the person views the content. For example, the remote server may use trained models to estimate the person's reaction/emotion based on the audiovisual data. At 312, control saves the data point comprising the person's profile, the date and time and location, and optionally the emotion/interest shown by the person for the location. The method 300 restarts and continues throughout the ride.

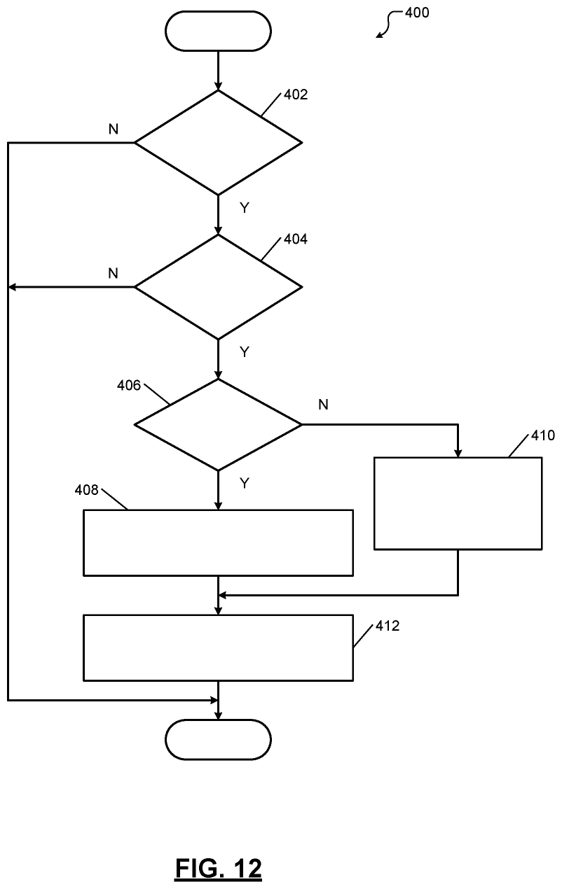

FIG. 11 shows a method 350 for detecting an occupant's interest in the music being played in the vehicle according to the present disclosure. At 352, control determines if music is being played on the radio in the vehicle. The method 350 ends if the radio is turned off. At 354, if music is being played in the vehicle, control detects body moment of a person using audiovisual and haptic sensors using trained models. For example, the remote server may use trained models that can detect a pattern such as a rhythm in a person's body movement captured by a camera and haptic sensors in the vehicle. For example, the trained models may be able to detect rhythmic tapping of fingers on the steering wheel, rhythmic finger snapping or clapping captured by a microphone, and so on. For example, control detects if the listener increased the volume of the music being played, which can indicate the listener's interest in the music being played.

At 356, control determines whether the detected body movement indicates that the person likes the music being played in the vehicle. The method 350 ends if the person does not like the music being played in the vehicle. At 358, if the person likes the music being played in the vehicle, control determines if information about the music such as the name of the track, the name of the singer, and so on is available on the radio. At 360, control collects the music information from the radio if the information is available on the radio. At 362, if the music information is not available on the radio, control obtains the music information using a music identification system implemented on a server or as a third party system. At 364, control saves the data point comprising the person's profile, the date and time and location, the music information, and the emotion/interest shown by the person for the music. The method 350 restarts and continues throughout the ride.

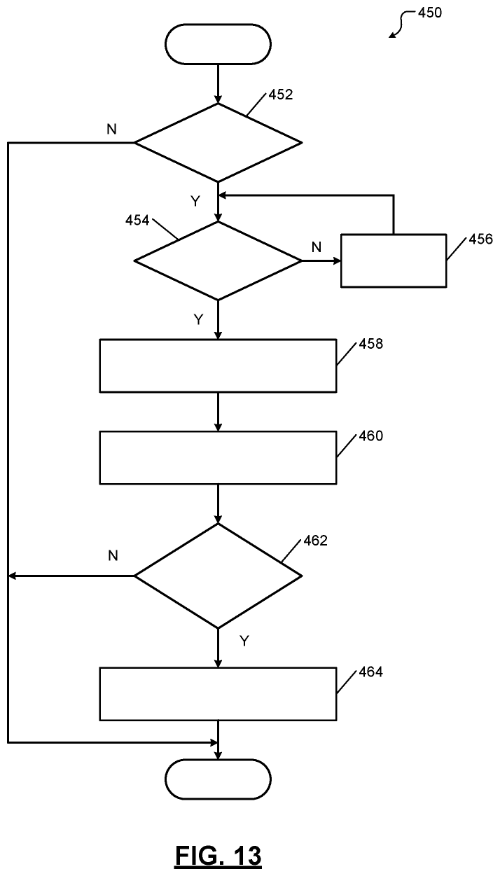

FIG. 12 shows a method 400 for detecting an occupant's interest in the music being played in the vehicle according to the present disclosure. At 402, control determines if music is being played on the radio in the vehicle. The method 400 ends if the radio is turned off. At 404, if music is being played in the vehicle, control determines if the radio station is changed or the radio is turned off. The method 400 ends if the radio station is changed or the radio is turned off since such actions indicate that the person does not like the music being played on the radio.

At 406, if the radio station is not changed or the radio is not turned off, such actions indicate that the person likes the music being played on the radio, and control determines if information about the music such as the name of the track, the name of the singer, and so on is available on the radio. At 408, control collects the music information from the radio if the information is available on the radio. At 410, if the music information is not available on the radio, control obtains the music information using a music identification system implemented on a server or as a third party system. At 412, control saves the data point comprising the person's profile, the date and time and location, the music information, and the emotion/interest shown by the person for the music. The method 400 ends.

Here, since the actions are binary (i.e., music playing or music turned off/changed) the method 400 concludes that all occupants like or dislike the music. The individual attribution is performed at the server end. For example, in a simplest scenario, if the vehicle has only one occupant, the attribution is made to that person's profile. If the vehicle has two occupants, the attribution to one or the other person can be made based on each person's past preferences recorded in their profiles. An audio input such as “turn it off” or “change the channel” or “I like/don't like it” can further help in attributing the preference to the correct person.

FIG. 13 shows a method 450 for presenting content to vehicle occupants based on their detected preferences according to the present disclosure. The method 450 describes step 214 of the method 200 shown in FIG. 8 in further detail. At 452, control determines if the system for detecting occupants and their preferences is enabled. The method 450 ends if the system is not enabled. At 454, if the system is enabled, control determines if all the doors of the vehicle are closed (i.e., all occupants are in the vehicle). If not, at 456, control resets the system and returns to 454. If the vehicle doors are closed, control proceeds to 458.

At 458, control detects identities (or fingerprints, voices, mobile devices) of all occupants of the vehicle (e.g., by capturing images of their faces, or data about their fingerprints, voices, or mobile devices and matching them to the corresponding data stored in a database in the remote server). At 460, control matches the detected identities to the corresponding profiles of the occupants (e.g., the profiles stored in a database in the remote server).

At 462, control determines whether a profile of a vehicle occupant shows an interest in an item whose supplier sells advertisements to the vehicle manufacturer. The method 450 ends if a profile of a vehicle occupant shows no interest in an item whose supplier sells advertisements to the vehicle manufacturer. At 464, if a profile of a vehicle occupant shows an interest in an item whose supplier sells advertisements to the vehicle manufacturer, control presents content such as an advertisement and/or a coupon for the item to the occupant (e.g., on a display associated with the occupant). In some implementations, the presentation can be in the form of an audio commercial on the music channel if the music channel is controlled by the vehicle manufacturer.

For example, if an occupant's interest in a billboard showing ads for vacations was detected, and if a company providing vacation packages sells ads to the vehicle manufacturer, such ads are presented to the occupant. For example, if an occupant's interest in a billboard showing ads for health clubs was detected, and if a company providing health club memberships sells ads to the vehicle manufacturer, such ads are presented to the occupant; and so on.

The preference data can be used in other ways. For example, the data regarding liking for music can be sold to radio stations, which can increase their listenership and advertising revenue resulting therefrom by playing more of the liked music than other music. In other examples, driving routes can be suggested based on preferences regarding landmarks and billboards. For example, a route involving an offensive billboard can be avoided. A scenic route can be suggested more often. Routes with billboards showing some type of advertisements can be preferred or avoided depending on the driver's taste or distaste for them. For example, routes with billboards showing ads for alcohol and gambling can be avoided, and routes with billboards showing ads for churches, sports, concerts, vacations, and so on can be preferred. Other uses are contemplated.

Music is used above as an example only. The teachings of the present disclosure can be extended to other types of content. For example, the teachings can be extended to news, podcasts, sportscasts, e-books, video channels, TV and other shows, movies, and any other type of content that can be streamed in vehicles.

Note that trained models can be stored in a remote server in a cloud and can be accessed by vehicles on demand via a network such as a cellular network. The facial images and profiles can also be stored in a database in the remote server and can be accessed by vehicles on demand via the network. The mapping data or maps including details about landmarks or points of interest can also be stored in a database in the remote server and can be accessed by vehicles on demand via the network. In instances where mapping data of vehicle surroundings is collected by the vehicle cameras on the fly, the collected data and the GPS data of the vehicle can be transmitted via the network to the remote server where it can be processed to determine the object gazed. Data about the preferences can be transmitted via the network to the remote server to be added to the profiles stored in the remote server.

Non-limiting examples of landmarks include buildings (gazing which can indicate interest in architecture), stores (gazing which can indicate interest in shopping generally and buying specific items based on the particular store), restaurants (gazing which can indicate interest in food generally and the type of food based on the particular restaurant), museums (gazing which can indicate interest in art), sports arenas (gazing which can indicate interest in sports), and so on. Further, gazing is not limited billboards, landmarks, or scenery; it also includes other objects such as cars, trucks, motorcycles, etc., gazing which can indicate interest in these objects. All of this information can be used to present tailed content to the occupants.

Alternatively, some of the above processing can be performed at the vehicle as well. For example, profiles of identified occupants can be downloaded via the network from the remote server to the vehicle. The profiles updated with any preference data can be subsequently uploaded via the network to the remote server. New facial images and new profiles created at the vehicle can also be uploaded via the network to the remote server. When available, the mapping data for a route can also be downloaded via the network from the remote server into the vehicle to quickly identify objects along the route being gazed by vehicle occupants. Some of the trained models can also be downloaded via the network from the remote server into the vehicle. Thus, all of the processing described above can be shared between the vehicle and the remote server to reduce latency and improve performance.

Throughout the present disclosure, various trained models are described. However, the teachings of the present disclosure are not limited to trained models. Alternatively or in additionally, artificial intelligence may be used.

The foregoing description is merely illustrative in nature and is not intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A method comprising:
detecting identities of occupants of a vehicle using any of a camera system, an audio system, a biometric sensing system, and a mobile device detection system in the vehicle;
matching the detected identities to corresponding profiles of the occupants, wherein the profiles include permissions set by the occupants for collecting data about preferences of the occupants;
perceiving, based on the permissions in the profiles, preferences of the occupants for inputs received by the occupants, wherein the perceiving includes capturing responses of the occupants to the inputs using any of the camera system, a haptic sensing system, and an audio system in the vehicle, and wherein the perceiving further includes processing the responses using trained models; and
adding the preferences to the profiles to provide content to the occupants based on the preferences stored in the profiles.

2. The method of claim 1 further comprising presenting content to the occupants on a device in the vehicle based on the preferences stored in the profiles.

3. The method of claim 1 further comprising suggesting a route for the vehicle based on the preferences stored in the profiles.

4. The method of claim 1 wherein the inputs include at least one of an object outside the vehicle and content being played in the vehicle.

5. The method of claim 1 wherein the inputs include a billboard, a landmark, an object, or scenery surrounding the vehicle.

6. The method of claim 1 further comprising creating a profile for one of the occupants not having a profile, receiving a permission setting from the one of the occupants, and perceiving preferences of the one of the occupants according to the permission setting.

7. The method of claim 1 wherein when the inputs include an object outside the vehicle, the method further comprising identifying the object using a GPS location of the vehicle and either a map of surroundings of the vehicle or data of the surroundings collected by the camera system while the object is perceived.

8. The method of claim 1 wherein when the inputs include an object outside the vehicle, the method further comprising:
detecting where one of the occupants is gazing based on a GPS location of the vehicle and either stored mapping data or concurrently collected data of surroundings of the vehicle; and
estimating whether the one of the occupants likes or dislikes the object based on an amount of time for which the one of the occupants views the object and by processing audiovisual data collected from the one of the occupants while viewing the object using one of the trained models.

9. The method of claim 1 wherein when the inputs include content being played in the vehicle, the method further comprising:
detecting an input from one of the occupants to a device playing the content;
determining whether the one of the occupants likes or dislikes the content based on the input;
collecting information about the content from the device or from an external source in response to the one of the occupants liking the content; and
storing the information in the profile of the one of the occupants.

10. The method of claim 1 wherein when the inputs include content being played in the vehicle, the method further comprising:
detecting body movement of one of the occupants responsive to the content being played using the trained models and any of the camera system, the haptic sensing system, the audio system;
estimating whether the one of the occupants likes or dislikes the content based on the detected body movement;
collecting information about the content in response to the one of the occupants liking the content; and
storing the information in the profile of the one of the occupants.

11. A system comprising:
an identity detection system installed in a vehicle, the identity detection system configured to:
detect identities occupants of the vehicle by recognizing any of faces, voices, fingerprints, or mobile devices of the occupants; and
match the detected identities to corresponding profiles of the occupants, wherein the profiles include permissions set by the occupants for collecting data about preferences of the occupants; and
a sensing system configured to, based on the permissions in the profiles:
sense responses of the occupants to inputs received by the occupants in the vehicle using any of a camera system, a haptic sensing system, and an audio system installed in the vehicle;
process the responses using trained models;
detect preferences of the occupants for the inputs; and
add the preferences to the profiles to provide content to the occupants based on the preferences stored in the profiles.

12. The system of claim 11 further comprising an infotainment system configured to present content to the occupants on a device in the vehicle based on the preferences stored in the profiles.

13. The system of claim 11 further comprising an infotainment system configured to suggest a route for the vehicle based on the preferences stored in the profiles.

14. The system of claim 11 wherein the inputs include at least one of an object outside the vehicle and content being played in the vehicle.

15. The system of claim 11 wherein the inputs include a billboard, a landmark, an object, or scenery surrounding the vehicle.

16. The system of claim 11 wherein the sensing system is further configured to:
create a profile for one of the occupants not having a profile;
receive a permission setting from the one of the occupants; and
perceive preferences of the one of the occupants according to the permission setting.

17. The system of claim 11 wherein when the inputs include an object outside the vehicle, the sensing system is further configured to identify the object using a GPS location of the vehicle and either a map of surroundings of the vehicle or data of the surroundings collected by the camera system while the object is perceived.

18. The system of claim 11 wherein when the inputs include an object outside the vehicle, the sensing system is further configured to:
detect where one of the occupants is gazing based on a GPS location of the vehicle and either stored mapping data or concurrently collected data of surroundings of the vehicle; and
estimate whether the one of the occupants likes or dislikes the object based on an amount of time for which the one of the occupants views the object and by processing audiovisual data collected from the one of the occupants while viewing the object using one of the trained models.

19. The system of claim 11 wherein when the inputs include content being played in the vehicle, the sensing system is further configured to:
detect an input from one of the occupants to a device playing the content;
determine whether the one of the occupants likes or dislikes the content based on the input;
collect information about the content from the device or from an external source in response to the one of the occupants liking the content; and
store the information in the profile of the one of the occupants.

20. The system of claim 11 wherein when the inputs include content being played in the vehicle, the sensing system is further configured to:
detect body movement of one of the occupants responsive to the content being played using the trained models and any of the camera system, the haptic sensing system, the audio system;
estimate whether the one of the occupants likes or dislikes the content based on the detected body movement;
collect information about the content in response to the one of the occupants liking the content; and
store the information in the profile of the one of the occupants.
